(19) United States
(12) Patent Application Publication
(10) Pub. No.: US 2015/0131666 A1
(43) Pub. Date: May 14, 2015

(54) APPARATUS AND METHOD FOR TRANSMITTING PACKET

(71) Applicant: ELECTRONICS AND TELECOMMUNICATIONS RESEARCH INSTITUTE, Daejeon (KR)

(72) Inventors: Saehoon KANG, Daejeon (KR); Sunhee YANG, Daejeon (KR)

(21) Appl. No.: 14/526,761

(22) Filed: Oct. 29, 2014

(30) Foreign Application Priority Data
Nov. 8, 2013 (KR) 10-2013-0135822

(51) Int. Cl. H04L 12/741; H04L 12/721

(52) U.S. Cl. CPC H04L 45/745; H04L 45/38
USPC 370/392

(57) ABSTRACT

In a software defined network, when an SDN switch receives a packet, the SDN switch calculates a flow entry index using a matching field value belonging to a matching rule that is extracted from the received packet and a flow matching mask field value representing whether a matching field belonging to a matching rule is a field that is designated as a wildcard, processes a packet that is received according to an action that is set to a flow entry that is matched to the flow entry index from a flow table.

### CROSS-REFERENCE TO RELATED APPLICATION

This application claims priority to and the benefit of Korean Patent Application No. 10-2013-0135822 filed in the Korean Intellectual Property Office on Nov. 8, 2013, the entire contents of which are incorporated herein by reference.

### BACKGROUND OF THE INVENTION

1. Field of the Invention

The present invention relates to a method and apparatus for transmitting a packet. More particularly, the present invention relates to a method in which a switch of a centralized control network transmits a packet according to a matching rule of a flow table.

2. Description of the Related Art

As an innovative structure that overcomes a structural limitation of a present network and that can accommodate new requirements, a centralized control network, for example, a software defined network (SDN), has been in the spotlight.

The SDN separates a control plane and a data plane in a network device such as a switch or a router and provides a standardized interface between the control plane and the data plane, and a central concentrative controller that is driven with a software method controls a packet path from the outside of the network device instead of processing a packet by a protocol that is formed in the network device and thus can very easily control and operate a network with a software method and allow easy development and application of a customized network service corresponding to a user request.

A typical example of the SDN is openflow technology. The controller calculates a packet path using an openflow protocol and transfers the packet path to the network device, and the network device stores and manages the path that is calculated by the controller at an entry of a flow table, and whenever receiving a packet, the network device searches for a flow table and transmits a packet to a designated path. The network device sends an inquiry about a packet that is not registered at the flow table to the controller and receives and processes determination of the controller.

In general, for efficient search of a flow table, a hash table or a ternary content addressable memory (TCAM) may be used. In a network device, when managing a flow table using a hash table, a method of exact matching that designates a value of an entire field that is used for matching is used. In this case, there is a merit that it can find an entry that is generally matched within a predetermined time, but a wildcard matching rule in which some field is not considered and that compares only the remaining fields is not supported.

For wildcard matching, a method of separating and sequentially searching for a wildcard matching rule in a separate table may exist, but the method requires a search time that is proportional to the number of wildcard matching rules and thus when the number of wildcard matching rules is large, it is hard to apply the method.

Another method of wildcard matching is a method of using a TCAM. When using a TCAM, there is a merit that it can find a matched entry within a predetermined time, but there is a burden that an additional apparatus should be mounted in each network device and a unit cost is higher than that of a general memory, and there is a drawback that storage power consumption and an occupying area are large. Further, because the number of fields that are used for flow classification is high, when a matching rule is long, processing performance is deteriorated.

In general, when classifying flow, a case of defining flow in consideration of only some necessary fields according to a network service is many rather than a case of considering an entire field constituting a matching rule and thus efficient processing of a wildcard matching rule is very important. By covering flow space of a wider range through a wildcard matching rule, a flow command request advancing from a network device to a controller may be reduced and this may be concluded as a load decrease of the controller. Therefore, in a network device, a method of enabling high speed flow matching for a wildcard matching rule without assistance of a separate apparatus such as a TCAM is requested.

### SUMMARY OF THE INVENTION

The present invention has been made in an effort to provide a method and apparatus for transmitting a packet having advantages of being capable of performing flow matching at a high speed for a wildcard matching rule without an additional apparatus in a centralized control network.

An exemplary embodiment of the present invention provides a packet processing apparatus in a software defined network. The packet processing apparatus includes a flow table and a packet processing engine. The flow table matches and stores a plurality of flow entries including a matching rule and an action according to flow to a plurality of flow entry indexes. The packet processing engine extracts a value of each matching field belonging to the matching rule from a received packet and a flow matching mask tag value representing whether each matching field is a field that is designated as a wildcard, determines a value of the matching field according to the flow matching mask tag value, and processes the received packet according to an action of a flow entry corresponding to a calculated first index using the determined matching field value.

Each bit of the flow matching mask field may correspond to each matching field and may represent whether the corresponding each matching field is a field that is designated as a wildcard.

A matching field corresponding to a corresponding bit may represent a field that is designated as wildcard matching when a bit of the flow matching mask tag is 1, and a matching field corresponding to a corresponding bit may represent a field that is designated as exact matching when a bit of the flow matching mask tag is 0.

The packet processing engine may change a value of a field that is designated as the wildcard among the extracted matching field values to a previously defined value.

The packet processing engine may update the flow table according to a flow command that is received from an SDN controller, when a flow entry corresponding to the first index does not exist at the flow table.

The flow command may include information of an action and information of a matching rule of the received packet, and the packet processing engine may determine a value of each matching field belonging to a matching rule that is included in the flow command and add a flow entry including the action and a matching rule that is included in the flow command to correspond to a calculated second index according to the determined matching field value to the flow table.

The information of the action may include an action that designates an output port to transfer the received packet.

The information of the action may further include an action that sets a flow matching mask tag corresponding to each matching field of a matching rule to be set to a next node to transmit the packet.

The information of the action may further include an action that removes a flow matching mask tag that is set to the packet.

The packet processing engine may determine whether the packet is a packet including a flow matching mask tag from an Ethernet type of the received packet.

The packet processing engine may use an output value of the hash function as the first index by inputting a value of the determined matching field to a hash function.

Another embodiment of the present invention provides a method in which an SDN switch processes a packet in a software defined network. The method includes: receiving the packet; calculating a first index using a value of each matching field belonging to a matching rule that is extracted from the packet and a flow matching mask tag representing whether the each matching field is a field that is designated as wildcard matching; searching for a flow entry corresponding to the first index from a flow table; and processing the packet according to an action that is set to a flow entry corresponding to the first index.

The calculating of a first index may include determining a value of each matching field according to a bit value of the flow matching mask tag, and determining an output value of a hash function using a value of each matching field as an input to the first index.

The determining of an output value may include changing a value of a field that is designated as the wildcard matching among values of each matching field to a previously defined value.

The method may further include: receiving a flow command from an SDN controller, when a flow entry that is matched to the first index does not exist; and processing the packet according to the flow command. The flow command may include information of a matching rule to process the packet and information of a corresponding action, and the information of a corresponding action may include at least one of setting a flow matching mask tag corresponding to a matching field of a matching rule to be set to a next node to transmit the packet and deletion of a flow matching mask tag that is set to the packet.

The processing of the packet may include updating the flow table with information of a matching rule that is included in the flow command.

The updating of the flow table may include: determining a value of each matching field belonging to a matching rule that is included in the flow command; calculating a second index according to the determined matching field value; and adding a matching rule that is included in the flow command and a flow entry including the action to the flow table to correspond to the second index.

A matching field corresponding to a corresponding bit may represent a field that is designated as wildcard matching, when a bit of the flow matching mask tag is 1.

A matching field corresponding to a corresponding bit may represent a field that is designated as exact matching, when a bit of the flow matching mask tag is 0.

The receiving of the packet may include determining whether the packet is a packet including a flow matching mask tag from an Ethernet type of the packet.

### BRIEF DESCRIPTION OF THE DRAWINGS

FIG. 1 is a diagram illustrating an example of a centralized control network according to an exemplary embodiment of the present invention.

FIG. 2 is a block diagram illustrating an SDN switch according to an exemplary embodiment of the present invention.

FIG. 3 illustrates a flow table according to an exemplary embodiment of the present invention.

FIG. 4 is a diagram illustrating a flow entry of FIG. 3.

FIG. 5 is a diagram illustrating a corresponding relationship between each bit and a matching field in a flow matching mask tag that is defined as a 32 bit length (b0-b31) according to an exemplary embodiment of the present invention.

FIG. 6 is a diagram illustrating an example of a packet including a flow matching mask tag according to an exemplary embodiment of the present invention.

FIG. 7 is a flowchart and a table illustrating a flow command processing method of an SDN switch according to an exemplary embodiment of the present invention.

FIG. 8 is a flowchart illustrating a method of processing a packet in an SDN switch according to an exemplary embodiment of the present invention.

FIG. 9 is a flowchart illustrating a method of processing a packet corresponding to a new flow in an SDN switch according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for transmitting a packet according to an exemplary embodiment of the present invention will be described in detail with reference to the drawings.

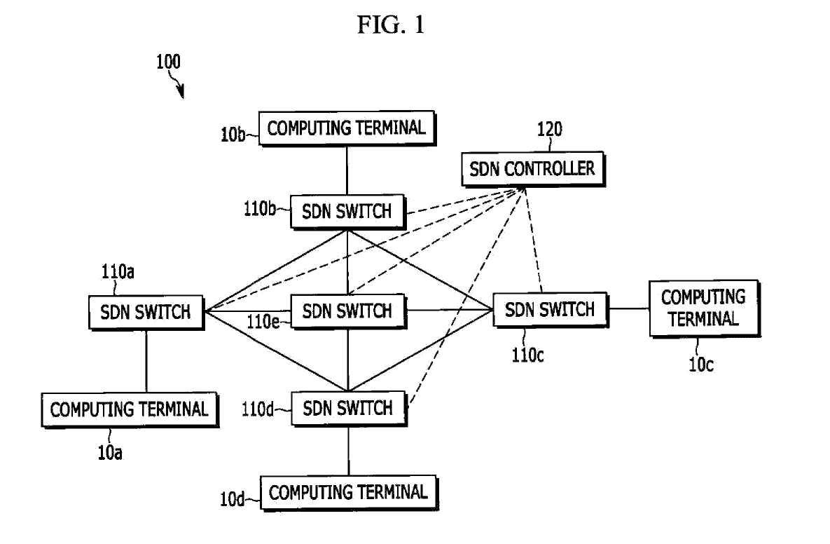

FIG. 1 is a diagram illustrating an example of a centralized control network according to an exemplary embodiment of the present invention.

Referring to FIG. 1, the centralized control network, for example a software defined network (SDN) 100, includes a plurality of SDN switches, for example, SDN switches 110a, 110b, 110c, 110d, and 110e corresponding to a packet transmission apparatus according to an exemplary embodiment of the present invention and an SDN controller 120.

The controller 120 has a centralized network control function and determines a path of a packet based on a parameter that is set according to a superordinate application or a policy request. A parameter used includes a load distribution condition or a weight value of a path that a user designates in addition to a shortest path or a line speed.

The SDN switches 110a, 110b, 110c, 110d, and 110e communicate with the controller 120 through a communication protocol, for example an open flow protocol, and may communicate with an in-band or out-band method.

The SDN switches 110a, 110b, 110c, 110d, and 110e store information of a path that is calculated by the controller 120 at a flow table, and process a packet that is received with reference to a flow table in a designated path whenever receiving a packet.

At least one of the SDN switches 110a, 110b, 110c, and 110d of the SDN switches 110a, 110b, 110c, 110d, and 110e may be connected to computing terminals 10a, 10b, 10c, and 10d, respectively.

The computing terminals 10a, 10b, 10c, and 10d are each a terminal that a user uses, such as a laptop computer, a smart phone, and a desktop PC.

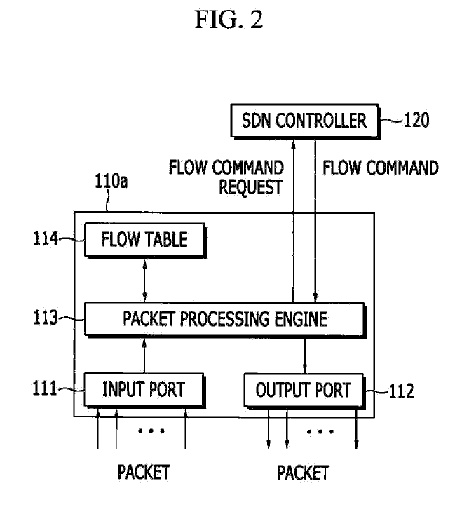

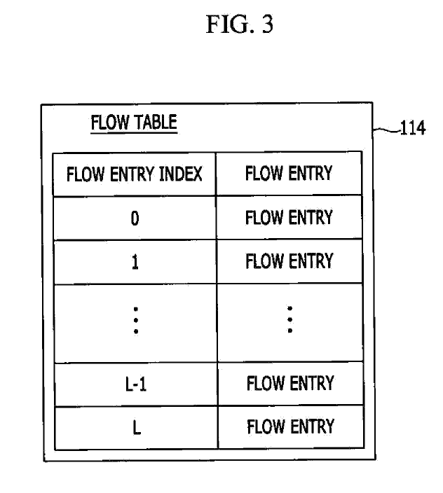

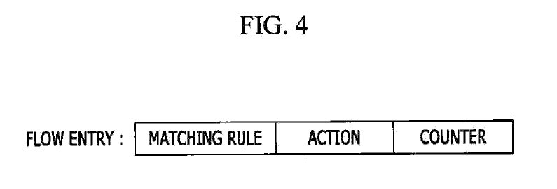

FIG. 2 is a block diagram illustrating an SDN switch according to an exemplary embodiment of the present invention, FIG. 3 illustrates a flow table according to an exemplary embodiment of the present invention, and FIG. 4 is a diagram illustrating a flow entry of FIG. 3.

FIG. 2 illustrates only the SDN switch 110a of the SDN switches 110a, 110b, 110c, 110d, and 110e, and the remaining SDN switches 110b, 110c, 110d, and 110e may be formed the same as the SDN switch 110a.

Referring to FIG. 2, the SDN switch 110a includes an input port 111, an output port 112, a packet processing engine 113, and a flow table 114.

The input port 111 receives, a packet from an adjacent node, for example an adjacent SDN switch 10a, or computing terminals 110b, 110d, and 110e, and the output port 112 transmits the packet to an adjacent node.

The packet processing engine 113 transfers the packet that is received by the input port 111 to an appropriate output port 112 with reference to the flow table 114. The packet processing engine 113 transfers the packet to an appropriate output port 112 according to a flow entry that is matched to a packet that is received with reference to the flow table 114.

When there is no flow entry that is matched to the packet that is received in the flow table 114, the packet processing engine 113 transfers a flow command request of the received packet to the SDN controller 120 through a security channel. The packet processing engine 113 receives a flow command from the SDN controller 120 through the security channel, adds a new flow entry that is matched with a corresponding packet to the flow table 114 based on the received flow command, and transfers the corresponding packet to an appropriate output port 112 according to the new flow entry. The flow command may include information of a matching rule of the corresponding packet and action information.

Referring to FIG. 3, the flow table 114 includes a plurality of flow entries corresponding to a plurality of indexes 1-L, respectively. Each flow entry includes information for packet processing on a flow basis, and each flow entry is distinguished with indexes 1-L.

Referring to FIG. 4, one flow entry includes a matching rule field and an action field. Further, one flow entry may include a counter field for managing statistical information, as needed.

The matching rule field includes a matching rule, i.e., condition information. Such a matching rule may be set as packet header information that defines flow. The matching rule may be designated with a combination of a field of a previously designated quantity and a designated length. The matching rule may include layer 1 to layer 3 related fields that may be generally extracted from a header of a packet, such as a MAC address, VLAN ID, an IP address, and a port number from a physical port number of a switch. Further, the matching rule may further include a layer 4 related field such as a TCP/UDP port number, and may use an additional field of an L4 layer or more according to an ability of the SDN switch.

In the flow table 114, each field belonging to a matching rule may have a specific value or may be designated as a previously defined “don't care” symbol, i.e., a wildcard symbol W that means that it may be matched to any value. For example, W may be designated as FFFF:FFFF:FFFF:FFFF. Alternatively, in a matching rule, a specific value is designated only to a value in which exact matching is necessary, and the “don't care” field may be omitted. In this case, in a field that is not designated when flow matching is not performed, wildcard matching is automatically performed.

When a packet is received, the SDN switch 110a parses the received packet, extracts a field value corresponding to each field constituting a matching rule, compares the field value with matching rules of the flow table 114, and searches for a matched flow entry.

Referring again to FIG. 4, an action field includes an action, i.e., a packet processing method. A packet processing method that can be designated as an action may include transmission, discard, update of a designated field value, and insertion of a specific tag.

A counter field includes statistical information. The statistical information represents a quantity of traffic that is transmitted/received on a flow entry basis with the number of packets and the number of bytes. When the SDN controller 120 calculates a path, such statistical information may be used as a parameter. For example, a packet may be transmitted to another path by bypassing a path having a large load.

In an exemplary embodiment of the present invention, in order to support indexing and searching of a wildcard matching rule on a hash table, a packet tag (hereinafter referred to as “flow matching mask tag”) of a new form of a flow matching mask is defined. A flow matching mask tag that is tagged on a packet header provides an indication about whether to apply exact matching or wildcard matching to each header field of a corresponding packet or some segment of a header field. For clear description, in an exemplary embodiment of the present invention, a header field of a packet and a segment constituting a header field are referred to as a matching field.

Each bit of a flow matching mask tag corresponds one-to-one to each matching field constituting a flow matching rule and represents whether a corresponding field and a field segment is a “don't care” matching field. For example, when a specific bit is set to 0, it represents an exact matching field in which field values should accurately correspond, and when a specific bit is set to 1, a field corresponding to the corresponding bit may represent a “don't care” field. When a field corresponding to the corresponding bit is a “don't care” field, a flow matching rule that is stored on a hash table is searched for using a value that is replaced with a wildcard symbol instead of an actual field value of a corresponding field upon flow matching, and thus flow matching is performed.

A flow matching mask tag is formed with bits of an n number and in this case, n is defined as a number that is larger than the number of matching fields constituting a flow matching rule.

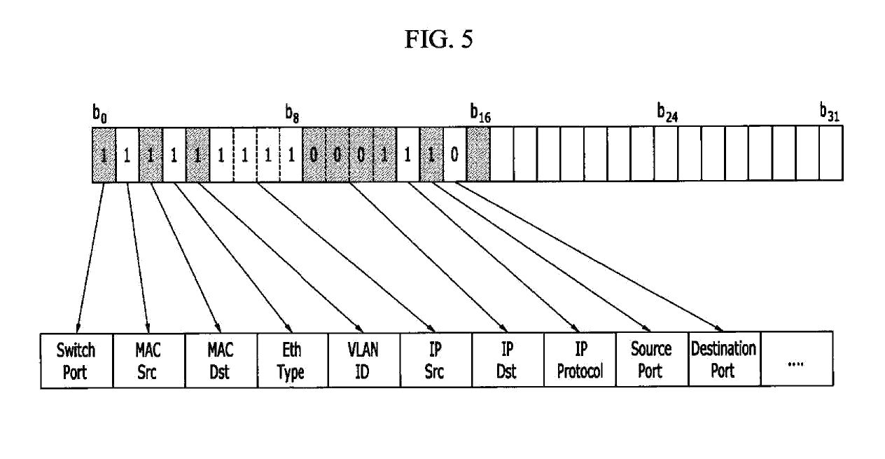

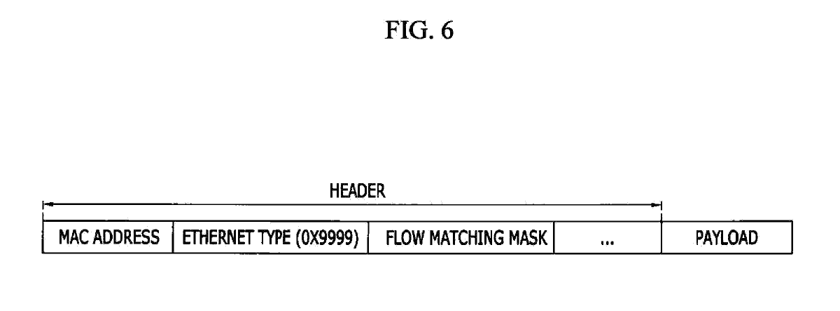

FIG. 5 is a diagram illustrating a corresponding relationship between each bit and a matching field in a flow matching mask tag that is defined with a 32 bit length (b₀-b₃₁) according to an exemplary embodiment of the present invention, and FIG. 6 is a diagram illustrating an example of a packet including a flow matching mask tag according to an exemplary embodiment of the present invention.

Referring to FIG. 5, bits b₀, b₁, b₂, b₃, and b₄ of the flow matching mask tag are mapped to a switch port, a source MAC address MAC Src, a destination MAC address MAC Dst, an Ethernet type Eth Type, and an KLAN identifier VLAN ID, respectively, and bits (b₅-b₈, b₉-b₁₂) of the flow matching mask correspond to a field segment of 8 bit lengths at source and destination IP addresses. Finally, bits b₁₃-b₁₅ are matched to a field such as an IP protocol, a source port, and a destination port.

In order to recognize whether the packet is a packet including a flow matching mask tag in the SDN switch, by allocating an intrinsic value to an Ethernet type on an L2 Ethernet frame format, a packet including a flow matching mask tag may be defined.

FIG. 6 illustrates a packet format of a case in which 0x9999 is allocated to an Ethernet type of a packet including a flow matching mask tag, and a header of the packet may include a MAC address field, an Ethernet type (0x9999) field, and a flow matching mask field.

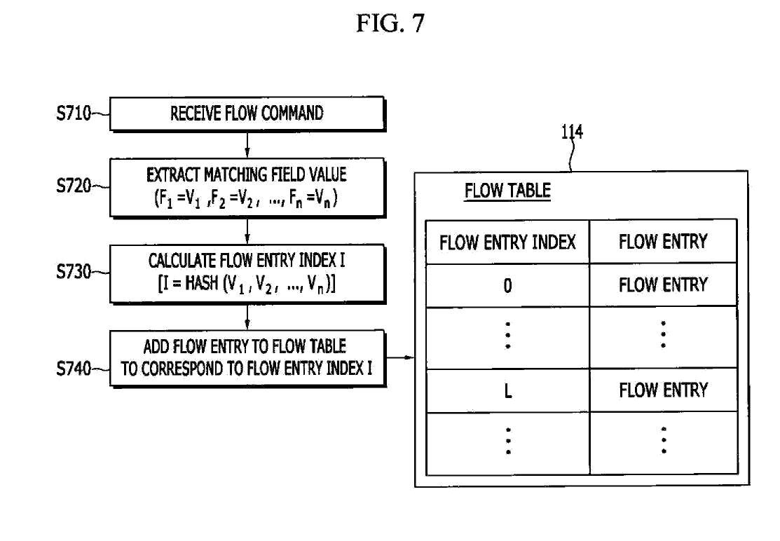

FIG. 7 is a flowchart and a table illustrating a flow command processing method of an SDN switch according to an exemplary embodiment of the present invention.

Referring to FIG. 7, when the packet processing engine 113 receives a flow command including information of a matching rule and information of an action from an SDN switch 110 (S710), the packet processing engine 113 extracts a matching field value (F₁=v₁, F₂=v₂, . . . , Fₙ=vₙ) belonging to a matching rule from information of a matching rule that is included in the flow command (S720). In this case, a field value that is not designated to the matching rule is replaced with a wildcard symbol.

The packet processing engine 113 calculates a flow entry index I to which a corresponding matching rule is to be added by inputting a matching field value (F₁=v₁, F₂=v₂, . . . , Fₙ=vₙ) belonging to a matching rule to a hash function [hash (v₁, v₂, . . . , vₙ)] (S730). The flow entry index I is a result value of a hash function [hash (v₁, v₂, . . . vₙ)].

The packet processing engine 113 adds a corresponding flow entry to the flow table 114 to correspond to the calculated flow entry index I (S740). That is, when a result value of a hash function is i, a corresponding flow entry is added to an I-th bucket of a flow table.

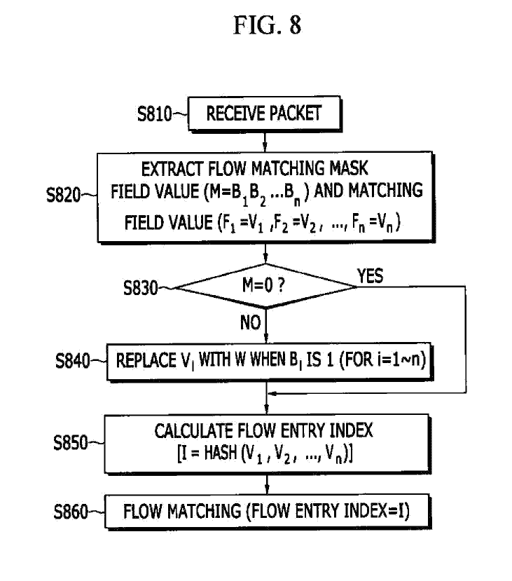

FIG. 8 is a flowchart illustrating a method of processing a packet in an SDN switch according to an exemplary embodiment of the present invention.

Referring to FIG. 8, when the packet processing engine 113 receives a packet (S810), the packet processing engine 113 of the SDN switches 110a, 110b, 110c, 110d and 110e determines whether the received packet is a packet including a flow matching mask tag using an Ethernet type of the received packet, and extracts a flow matching mask field value M={b₁b₂ . . . bₙ} and a mapping field value (F₁=v₁, F₂=v₂, . . . , Fₙ=vₙ) belonging to a matching rule (S820). When a flow matching mask tag is not included in a packet, exact matching is performed in an entire matching field and thus a flow matching mask value M is set to 0.

The packet processing engine 113 determines whether a flow matching mask field value M that is extracted at step S820 is 0 (S830). When the flow matching mask field value M is not 0, it represents that wildcard matching should be performed for a field corresponding to a bit that is set to 1, and when the flow matching mask field value M is 0, it represents that exact matching should be performed for an entire matching field.

When the flow matching mask field value M is not 0, the packet processing engine 113 replaces a field value of a matching rule corresponding to a bit having 1 among the flow matching mask field value M with W, which is a previously defined wildcard symbol value (S840), and calculates a flow entry index I by inputting a matching field value (F₁=v₁, F₂=v₂, . . . , Fₙ=vₙ) constituting a matching rule to a hash function [hash (v₁, v₂, . . . , vₙ)] (S850).

When a flow entry index I is calculated, the packet processing engine 113 has the calculated flow entry index I and performs flow matching (S860). Flow matching is work that searches for whether a flow entry that is matched to a flow entry index I that is calculated in the flow table 114 exists and that determines whether a packet that is received in a flow rule that is included in the found flow entry is matched, and when flow matching has succeeded, the packet processing engine 113 processes a received packet according to an action that is defined to the found flow entry.

In contrast, when a flow entry that is matched to the flow entry index I does not exist or even if a flow entry that is matched to the flow entry index I exists, when an included flow rule is not matched to a received packet, the SDN switch 110a requests a flow command of the received packet from the SDN controller 120.

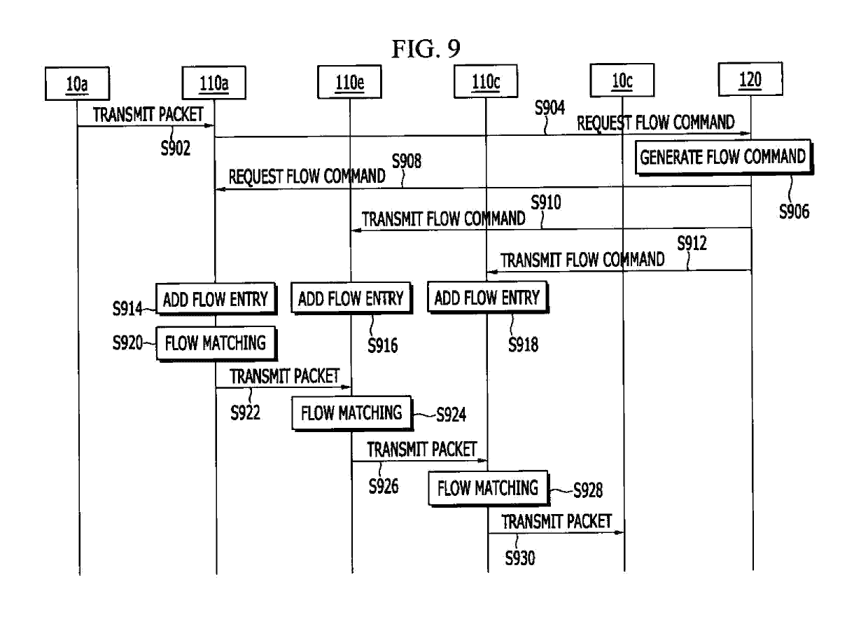

FIG. 9 is a flowchart illustrating a method of processing a packet corresponding to new flow in an SDN switch according to an exemplary embodiment of the present invention. FIG. 9 illustrates a method in which the SDN switches 110a, 100e, and 100c process a packet belonging to a new flow advancing from the computing terminal 10a to the computing terminal 10c. Because the entire SDN switches 110a, 100e, and 100c of FIG. 9 manage a flow entry using a hash table, all SDN switches 110a, 100e, and 100c are assumed to be switches that do not support a matching rule including a wildcard.

Referring to FIG. 9, the computing terminal 10a transmits a packet to a directly connected SDN switch 110a (S902).

The SDN switch 110a, having received a corresponding packet from the computing terminal 10a, performs flow matching of a received packet like the method that is described in FIG. 8.

When flow matching has succeeded, the SDN switch 110a processes a packet that is received from the computing terminal 10a according to an action of the matched flow entry.

However, in a case of FIG. 9, the packet that is received from the computing terminal 10a is a packet belonging to the new flow. Therefore, because a flow entry of a corresponding packet does not exist at the flow table 114, flow matching fails.

When flow matching has failed, the SDN switch 110a requests a flow command of a corresponding packet from the SDN controller 120 (S904).

The SDN controller 120 having received the flow command request determines a path of a corresponding packet according to a path determination algorithm, generates a flow command to transfer to each of the SDN switches 110a, 110e, and 110c on the path (S906), and transmits each flow command to the respective SDN switches 110a, 110e, and 110c (S908, S910, and S912). In this case, the flow command may include an action such as insertion and deletion of a flow matching mask tag and setting of a flow matching mask tag value when the SDN controller 120 defines flow using a wildcard matching rule in addition to an action for general path setting. Insertion and deletion of a flow matching mask tag are general action functions that are supported in an SDN, and openflow 1.3 supports an insertion and deletion action of an MPLS and VLAN related tag. In FIG. 9, it is assumed that the SDN controller 120 determines an exact matching rule with a matching rule to transfer to the SDN switch 110a, and determines a wildcard matching rule with a matching rule to transfer to the SDN switches 110e and 110c.

A flow command that is transferred from the SDN controller 120 to the SDN switch 110a may include an action that designates an output port to transfer an exact matching rule and a received packet, and an action that adds a flow matching mask field to a received packet and an action that sets a flow matching mask tag to a flow matching mask field. In this case, each bit of a flow matching mask tag corresponds to each matching field of a matching rule to be set to a next SDN switch 110e on a determined path, and is set as 1 or 0 according to whether a matching field of a matching rule includes a wildcard.

However, a flow command that is transferred to the SDN switch 110e, which is an intermediate node, may include an action that designates an output port to transfer a wildcard matching rule and a received packet and an action that newly sets a flow matching mask tag according to a field that is designated to a wildcard among each matching field of a matching rule to be set, to the SDN switch 110c, which is a next node.

A flow command that is transferred to the SDN switch 110c, which is a final node on a path, may include an action that designates an output port to transfer a wildcard matching rule and a received packet and an action that removes a flow matching mask field.

When the SDN switches 110a, 110e, and 110c receive a corresponding flow command from the SDN controller 120, the SDN switches 110a, 110e, and 110c extract each matching field value of a matching rule from information of a matching rule that is included in the flow command, input the values to a hash function, and add a new flow entry to the flow table 114 using a result value thereof as a flow entry index of the flow table 114 (S914, S916, and S918).

Because a packet received from the computing terminal 10a does not include a flow matching mask field, the SDN switch 110a extracts a value of a matching field belonging to a matching rule from a packet that is received from the computing terminal 10a, calculates a flow entry index, has a flow entry corresponding to the calculated flow entry index, and performs flow matching (S920). The SDN switch 110a adds a flow matching mask tag to a packet that is received from the computing terminal 10a according to an action of the matched flow, entry, sets a flow matching mask tag value, and transfers the flow matching mask tag value to the SDN switch 110e (S922).

When receiving a packet, the SDN switch 110e extracts a flow matching mask field value and a matching field value belonging to a matching rule from the received packet, like the method that is described in FIG. 8, replaces a value thereof with a wildcard symbol, calculates a flow entry index in a field in which wildcard matching is necessary with reference to a flow matching mask field value, has a flow entry corresponding to the calculated flow entry index, and performs flow matching (S924). The SDN switch 110e performs an action necessary for a packet that is received from the SDN switch 110a according to an action of the matched flow entry and transfers the action to the SDN switch 110c (S926). In this case, an action of resetting a flow matching mask tag may be performed.

When the SDN switch 110c receives a packet, the SDN switch 110c calculates a flow entry index by extracting a flow matching mask field value and a value of a matching field belonging to a matching rule from the received packet, has a flow entry corresponding to the calculated flow entry index, and performs flow matching (S928). The SDN switch 110e performs an action necessary for a packet that is received from the SDN switch 110e according to an action of the matched flow entry and transmits the action to the computing terminal 10c (S930). In this case, an action of deleting a flow matching mask tag may be performed.

In this way, the SDN switches 110e and 110c may process a packet according to a wildcard matching rule using a value of a flow matching mask field even without special hardware such as a TCAM.

According to an exemplary embodiment of the present invention, flow matching based on a wildcard matching rule can be supported at a high speed even without assistance of special hardware such as a TCAM. Further, in an SDN controller, because a wildcard matching rule-based flow entry can be freely set to each SDN switch, by reducing an occurrence frequency of new flow, a new flow command request to an SDN controller can be reduced, and by reducing a load of the SDN controller, a result that improves overall performance of a network can be obtained.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from the description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A packet processing apparatus in a software defined network, the packet processing apparatus comprising:
a flow table that matches and stores a plurality of flow entries comprising a matching rule and an action according to flow to a plurality of flow entry indexes; and
a packet processing engine that extracts a value of each matching field belonging to the matching rule from a received packet and a flow matching mask tag value representing whether each matching field is a field that is designated as a wildcard, and that determines a value of the matching field according to the flow matching mask tag value and processes the received packet according to an action of a flow entry corresponding to a calculated first index using the determined matching field value.

2. The packet processing apparatus of claim 1, wherein each bit of the flow matching mask field corresponds to each matching field and represents whether the corresponding each matching field is a field that is designated as a wildcard.

3. The packet processing apparatus of claim 2, wherein a matching field corresponding to a corresponding bit represents a field that is designated as wildcard matching when a bit of the flow matching mask tag is 1, and a matching field corresponding to a corresponding bit represents a field that is designated as exact matching when a bit of the flow matching mask tag is 0.

4. The packet processing apparatus of claim 2, wherein the packet processing engine changes a value of a field that is designated as the wildcard among the extracted matching field values to a previously defined value.

5. The packet processing apparatus of claim 2, wherein the packet processing engine updates the flow table according to a flow command that is received from an SDN controller, when a flow entry corresponding to the first index does not exist at the flow table.

6. The packet processing apparatus of claim 5, wherein the flow command comprises information of an action and information of a matching rule of the received packet, and
the packet processing engine determines a value of each matching field belonging to a matching rule that is included in the flow command and adds a flow entry comprising the action and a matching rule that is included in the flow command to correspond to a calculated second index according to the determined matching field value to the flow table.

7. The packet processing apparatus of claim 6, wherein the information of the action comprises an action that designates an output port to transfer the received packet.

8. The packet processing apparatus of claim 7, wherein the information of the action further comprises an action that sets a flow matching mask tag corresponding to each matching field of a matching rule to be set to a next node to transmit the packet.

9. The packet processing apparatus of claim 7, wherein the information of the action further comprises an action that removes a flow matching mask tag that is set to the packet.

10. The packet processing apparatus of claim 1, wherein the packet processing engine determines whether the packet is a packet comprising a flow matching mask tag from an Ethernet type of the received packet.

11. The packet processing apparatus of claim 1, wherein the packet processing engine uses an output value of a hash function as the first index by inputting a value of the determined matching field to a hash function.

12. A method in which an SDN switch processes a packet in a software defined network, the method comprising:
receiving the packet;
calculating a first index using a value of each matching field belonging to a matching rule that is extracted from the packet and a flow matching mask tag representing whether each matching field is a field that is designated as wildcard matching;
searching for a flow entry corresponding to the first index from a flow table; and
processing the packet according to an action that is set to a flow entry corresponding to the first index.

13. The method of claim 12, wherein the calculating of a first index comprises:
determining a value of the each matching field according to a bit value of the flow matching mask tag; and
determining an output value of a hash function using a value of each matching field as an input to the first index.

14. The method of claim 13, wherein the determining of an output value comprises changing a value of a field that is designated as the wildcard matching among values of each matching field to a previously defined value.

15. The method of claim 12, further comprising:
receiving a flow command from an SDN controller when a flow entry that is matched to the first index does not exist; and
processing the packet according to the flow command,
wherein the flow command comprises information of a matching rule to process the packet and information of a corresponding action, and
the information of a corresponding action comprises at least one of setting a flow matching mask tag corresponding to a matching field of a matching rule to be set to a next node to transmit the packet and deletion of a flow matching mask tag that is set to the packet.

16. The method of claim 15, wherein the processing of the packet comprises updating the flow table with information of a matching rule that is included in the flow command.

17. The method of claim 16, wherein the updating of the flow table comprises:
determining a value of each matching field belonging to a matching rule that is included in the flow command;
calculating a second index according to the determined matching field value; and
adding a matching rule that is included in the flow command and a flow entry comprising the action to the flow table to correspond to the second index.

18. The method of claim 12, wherein a matching field corresponding to a corresponding bit represents a field that is designated as wildcard matching, when a bit of the flow matching mask tag is 1.

19. The method of claim 12, wherein a matching field corresponding to a corresponding bit represents a field that is designated as exact matching, when, a bit of the flow matching mask tag is 0.

20. The method of claim 12, wherein the receiving of the packet comprises determining whether the packet is a packet comprising a flow matching mask tag from an Ethernet type of the packet.
